(19) United States
(12) Patent Application Publication
(10) Pub. No.: US 2005/0107274 A1
(43) Pub. Date: May 19, 2005

(54) Removal of post etch residues and copper contamination from low-k dielectrics using supercritical CO2 with diketone additives

(76) Inventor: Jerome Daviot, Massy (GB)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 10/966,655

(22) Filed: Oct. 14, 2004

Related U.S. Application Data
(60) Provisional application No. 60/511,949, filed on Oct. 14, 2003.

(51) Int. Cl. C23G 1/00; C11D 1/00

(52) U.S. Cl. 510/175; 134/2

(57) ABSTRACT

The present invention provides for methods and compositions for removal of post etch residues and copper contamination from low-k dielectrics and substrates using supercritical CO₂ with diketone additives. Using methods of this invention, Cu-residues formed during dielectric etch were removed with an high efficiency. Various process conditions are presented in order to exemplify the cleaning mechanisms.

### CROSS REFERENCE TO RELATED APPLICATIONS

The present application claims priority to Provisional Patent Application No. 60/511,949, filed Oct. 14, 2003, which is hereby incorporated herein by reference in its entirety.

### FIELD OF THE INVENTION

The present invention generally relates to methods and compositions for cleaning semiconductor substrates using supercritical CO₂. The invention more particularly relates to removal of post etch residues and copper contamination from low-k dielectrics using supercritical CO₂ with a diketone additive.

### BACKGROUND

Devices whose dimensions are on scales as small as 0.09 μm have involved the integration of porous low-k dielectrics. Chip manufacturers are using low-k substances with dielectric constants of 2.65 to 3.0 and lower. With chip geometries continuing to shrink, manufacturers are anxious for materials with even lower dielectric constants. Low-k materials are generally substances that are less dense than silicon dioxide and is critical to advanced semiconductor manufacturing because it allows metal lines to be packed closer together on a chip with less risk of electrical signal leakage. This demand indicates a trend toward porous materials that have been referred to as ultra, low-k material (ULK). Fabrication of such devices has required improvements in cleaning technology, particularly in decontamination, because of the increased porosity, and via etching, because during dual Damascene integration, copper species can be back sputtered from the underlying copper line onto via and trench sidewalls of the dielectric stacks. Dielectric materials can become contaminated, in particular porous dielectric materials where the contamination occurs within the porous matrix of the dielectric material. The trend toward the use of copper interconnects exacerbates the problems regarding decontamination and cleaning due to the ability of copper to diffuse into the porous dielectric material. The resulting Cu contamination must be removed from the porous matrix to prevent irreversible electrical breakdown and yield loss. The detrimental impacts of copper contamination have been recognized as critical for ULK materials and overall device performances. Additionally, post etch residues (PER) can contain copper contaminants, which must also be removed. Therefore, cleaning processes are becoming necessary to remove copper contamination and have become vital for porous ULK integration in modern integrated circuit (IC) fabrication. However, the processes have to be efficient enough to remove both the Cu contamination and post etch-residues while simultaneously preserving the Cu lines and the ULK materials. Aqueous cleaning methods are problematic because the high surface tension of water can cause structures on such small scales to become fused to one another during the process of wetting and drying.

Additional concerns in the semiconductor industry are environmental: historically, photoresists, for example, have been removed in front end of line (FEOL) processes as well as back end of line (BEOL) processes, both of which have used large volumes of potent and toxic chemicals. Such chemicals are not only costly in themselves but also require copious amounts of deionized water for washing, and also require costly disposal methods.

Supercritical CO₂-based treatments (SC CO₂) provide promising alternative methods, compared to conventional cleaning processes such as aqueous-based cleaning that utilize H₂SO₄, due to its unique characteristics. SC CO₂ is an inert solvent that behaves as both a liquid and a gas (see, e.g., A. Danel, C. Millet, V. Perrut, J. Daviot, V. Jousseaume, O. Louveau, D. Louis, Proceedings of the IEEE International Interconnect Technology Conference (2003), pp. 248-250). Specifically, SC CO₂ has a liquid-like density, a gas-like diffusivity, and viscosity and an effective surface tension near zero. SC CO₂ based cleaning processes appear to be an attractive solution because of the capacity of SC CO₂ to decontaminate even within the ULK matrix. SC CO₂ can penetrate small pores but will evaporate very easily and has low surface tension that does not disrupt fine scale structures. SC CO₂ is also favorable because of various environmental benefits associated with its use.

Nevertheless, supercritical CO₂ by itself is not able to effectively remove copper residues under conditions typically employed in industry (up to 150° C. and 300 bar) without some additive. Fortunately, SC CO₂ can dissolve many organic molecules—particularly non-polar molecules—to form a homogeneous liquid solution. Additionally, in the supercritical state, CO₂ is a medium that can transport active chemicals within the porous ULK matrix without damaging the surrounding material. Consequently, it is desirable to find a composition that, in conjunction with super-critical CO₂, will effectively lift copper-containing residues from substrate surfaces in such a way that as little damage as possible is wrought on copper lines and the underlying substrate.

U.S. Pat. Nos. 5,868,856 and 5,868,862, to Douglas, et al., describe removing inorganic contamination from, respectively, the surface of a semiconductor substrate, and a layer overlying a substrate, using a supercritical fluid. However, both patents describe methods that require an agent that reacts with the inorganic contamination, thereby rendering it more soluble in the supercritical fluid, and both teach away from using a chelating agent, dissolved in the super critical fluid, for complexing metal ions.

Certain chelating agents when dissolved in SC CO₂ have been shown to dissolve various heavy metal ions. For example, Meguro et al., demonstrated that various β-diketones—including fluorinated β-diketones—in combination with trialkylphosphate or trialkylphosphine oxide, can facilitate dissolution of actinide and lanthanide ions in SC CO₂ when using SC CO₂ as an extraction medium (see, e.g., U.S. Pat. No. 5,730,874, to Wai, et al.). However, it has been observed that the extraction efficacy of the SC CO₂ composition was one to two orders of magnitude less than the efficacy of an organic solvent such as cyclohexane (see Y. Meguro, S. Iso, J. Ougiyanagi, and Z. Yoshida, “Extraction of Uranium (VI) and Lanthanide (III) Ions into Supercritical Carbon Dioxide Fluid Containing β-Diketone and Tributylphosphate”, Analytical Sciences, Vol. 17 Suppl., pp. i721-i724, (2001)).

U.S. Pat. No. 6,610,152 B1, to Babain et al., describes extraction of metal ions—typically radionuclides such as uranium and plutonium—from a solid surface using supercritical CO₂ containing an acidic ligand such as a β-diketone, and an organic amine. However, this publication does not teach that one of the metals that can be removed is copper.

U.S. Pat. No. 6,555,916 B2, to Nguyen et al., describes removal of copper oxides from an integrated circuit surface by using a diketone, delivered in vapor form. However, this invention requires a surface layer on the integrated circuit to be maintained in the temperature range 100-450° C.

U.S. Pat. No. 6,764,552 B2, to Joyce et al., describes the use of supercritical solutions for removing photoresist and post etch residues from low-k materials. However, the solutions include an ammonium hydroxide, ammonium carbonate or ammonium bicarbonate, which are not preferred in the present invention due to solubility considerations within supercritical carbon dioxide. The solutions also do not distinguish in cleaning performance among the long list of permitted components, particularly not distinguishing the β-diketones, and γ-diketones classes of diketones of the present invention.

With the continuing reduction in electronic product size, combined with the increased need for production efficiencies due to lower premiums and the continuing need for high performance, there is a need for an effective cleaning and decontamination chemistry that is able to meet the challenges presented with new technology dielectrics and interconnect metallurgies.

### SUMMARY OF THE INVENTION

The present invention provides a process for removal of Cu-containing contaminants from low-k, and ultra-low-k, dielectrics, including and in particular, porous dielectric materials, and for removal of post-etch residues from substrate surfaces, using super-critical CO₂ in which a diketone chelating agent is dissolved.

The cleaning methods of the present invention target the removal of one or more of: (i) Cu contamination trapped inside ULK bulk, (ii) post etch residues, and (iii) the layer of oxidized copper on Cu lines. The methods of the present invention may be further optimized for selectivity between oxidized and metal copper.

The cleaning compositions of the present invention suitable for removing a copper-containing contaminant from a substrate comprise: super-critical carbon dioxide, a diketone, and a co-solvent. When applied to removing post-etch residue, the cleaning composition may further comprise an acid.

According to the present invention, the diketone compound has the formula R₁—CO—(Y)ₙ—CO—R₃, wherein Y═C(R₂)(R₂′), n=1-3, and R₁, R₂, R₂′, and R₃ are each independently selected from hydrogen, alkyl, aryl, fluorine-substituted alkyl, alkoxy, furyl, substituted furyl, thienyl and substituted thienyl.

According to the present invention, the diketone compound is preferably selected from the group consisting of: acetonylacetone (CH₃COCH₂CH₂COCH₃), acetylacetone, trifluoroacetylacetone, hexafluoroacetylacetone, thienoyltrifluoroacetylacetone, and 2,2-dimethyl-6,6,7,7,8,8,8-heptafluoro-3,5-octanedione, and 2,2,6,6-tetramethylheptane-3,5-dione.

The cleaning composition of the present invention preferably contains a co-solvent that preferably has a polar characteristic. The solvent may be a substituted aliphatic hydrocarbon, including an alcohol, amine, alkyl halide, halocarbon, ketone, amide, and combinations thereof, that is in the liquid phase under the conditions of use with the present invention. In preferred embodiments, the co-solvent is selected from the group consisting of: ethanol, butyne-2-one, dimethyl acetamide, and γ-butyrolactone.

The cleaning composition of the present invention, when applied to post-etch residue removal, preferably contains an organic acid having a formula: R—Ar—XOₘHₚ, wherein R is an aliphatic chain—straight or branched—with from 1 to 20 carbon atoms, preferably from 5 to 15 carbon atoms, and even more preferably 10 carbon atoms, and wherein a number of hydrogens on R may be substituted with an equivalent number of fluorine atoms, and wherein Ar is optionally present and represents an arylene group such as phenylene, naphthylene, anthracenyl, in which any two of its substitutable positions is occupied, and wherein XOₘ represents an inorganic acid group wherein X is S, N, P. Se, or As, and wherein m is a number between 1 and 4 and p is a number between 1 and 3 such that the normal valences of the atom X are satisfied. In preferred embodiments, XOₘHₚ is selected from the group consisting of: NO₂H, NO₃H, SO₃H, SO₄H, PO₃H, and PO₄H₂.

The compositions of the present invention preferably comprise: about 2-6% by volume of co-solvent, about 2-6% by volume of acid, and about 2-6% by volume of chelating agent, the balance being made up with supercritical CO₂. The composition may also contain up to about 2% by volume, water.

The cleaning process, for example, includes placing the substrate to be cleaned within the cleaning area, which is commonly referred to as the reactor. The reactor is then pressurized to preferably about 90 to about 190 bars and at a temperature of preferably about 40 to about 90 C with carbon dioxide. The additional liquid components of the cleaning composition is then injected into the cleaning area over a period of time—preferably about 20 to about 300 seconds. During this period of time, the cleaning composition contacts at least one surface of the substrate to be cleaned to remove the PER or photoresist and/or decontaminate the dielectric material. A rinsing composition is preferably added to the cleaning area over a period of time—preferably about 120 seconds, after which the cleaning area may be depressurized. In a preferred embodiment, at least a portion of the cleaning composition is recovered and/or recycled.

A preferred rinsing solution is ethanol, although other appropriately selected rinsing solutions may be used such as dimethyl acetamide (DMAc).

### BRIEF DESCRIPTION OF THE DRAWINGS

FIG. 1 shows wafer architecture tested (second line level on a first level of Cu lines);

FIG. 2 shows embodiment of an apparatus for cleaning a semiconductor wafer using the methods of the present invention;

FIG. 3 contains SIMS analyses showing copper contamination level vs. ULK thickness, before, and after two different cleaning methods;

FIG. 4 is a chart showing remaining Cu contamination vs. cleaning time by hfac/ethanol dissolved in SC CO₂;

FIG. 5 is a chart showing Cu decontamination efficiency results of different chelating agents dissolved in SC CO₂;

FIG. 6 is a chart showing cleaning efficiency of SC CO₂/hfac/solvent cleaning vs. solvent dielectric constant;

FIG. 7 shows XPS spectra (a) before, and (b) after, a CO₂hfac/ethanol cleaning;

FIG. 8 shows SEM pictures of various cleaning regimes: -a- before cleaning; -b- after a reference wet cleaning; -c- after a SC CO₂ cleaning using hfac/ethanol; -d- after a SC CO₂ cleaning using acid/ethanol; and -e- and -f-, after a SC CO₂ cleaning using acid/hfac/ethanol (at two different acid concentrations);

FIG. 9 presents tilted SEM micrographs of copper/JSR feature after SCCO2 treatment;

FIG. 10 shows a comparison of Cu PER cleaning with an optimized composition of the present invention and a traditional organic PER cleaner;

FIG. 11 shows a comparison of cleaning ability of compositions of the present invention with different amounts of water content;

FIG. 12 shows a comparison of cleaning ability of compositions of the present invention with different solvents;

FIG. 13 shows a SIMS graph of the Cu signal for JSR as deposited and after ash;

FIG. 14 shows a SIMS graph of the Cu signal for Orion® after etch/ash;

FIG. 15 shows leakage current measurements on Orion®;

FIG. 16 shows the DOE optimizer response for acetyl acetone/DDBSA/SC CO₂ cleaning and corrosion measurements; and

FIG. 17 shows SEM pictures for solutions of various reagents in SC CO₂.

### DETAILED DESCRIPTION

The present invention is directed to removal of Cu-containing contaminants from dielectrics, particularly porous dielectric materials, and substrate surfaces, using super-critical CO₂ within which a diketone chelating agent and a co-solvent are dissolved. The present invention is further directed to removal of post-etch residues (PER) using super-critical CO₂ within which a diketone chelating agent, an organic acid, and a co-solvent are dissolved, alone or in combination with simultaneously removing Cu-containing contaminants from dielectrics. It has also been found that the methods and compositions of the present invention are effective at removing photo-resist (PR), particularly in areas where the photoresist has not been exposed to plasma.

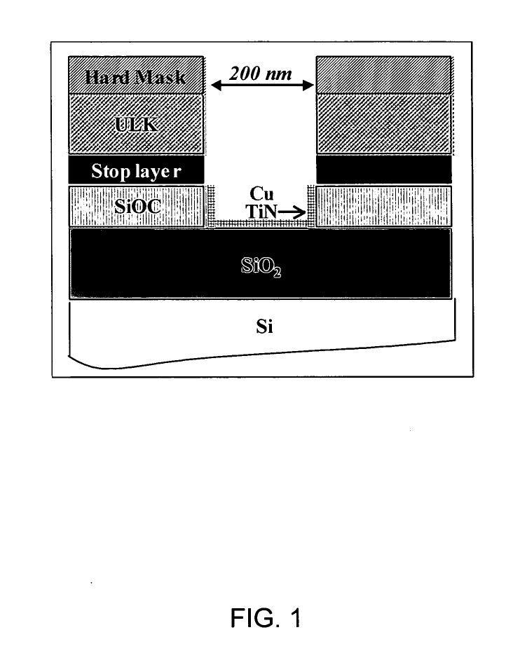

FIG. 1 shows damascene structures typical of those to which the methods and compositions of the present invention can be applied. Commonly used low-k dielectrics to which the methods and compositions of the present invention may be suitably applied include, but are not limited to: Fluorosilicate glass; HSQ, Porous HSQ, GX-3p, Orion®, siLK™, SiOC, Nanoglass™, HOSP™, Coral™, GaAs, TEOS, mesoELK, MSQ, Porious MSQ, or the like low-k materials; and hybrid organic-inorganic materials. The more such materials are porous, the greater the ability of Cu contaminants to diffuse through such material. Typical porosities may be found in the range of about 2-40 nm.

Post etch residue, as contemplated by the methods and compositions of the present invention, typically comprises CuF₂, CuF, and carbonaceous residues containing various organometallics.

The results presented herein demonstrate that supercritical CO₂-based treatment for copper contamination and PER removal is a very promising cleaning technology. Indeed, more than being compatible with most of the materials currently used in integrated circuits, SC CO₂/additive cleaning can be very efficient (more than 99%) to remove copper residues inside a porous ULK material film. It is also envisaged that the methods and compositions of the present invention may be applicable to removal of other residues, including aluminum (Al), tungsten and their oxides, particularly from structures that are smaller than 30 nm.

Efficient metal extraction in SC CO₂ can be achieved with diketone compounds as chelating agents. Two classes of diketone chelating agents, β-diketones, and γ-diketones, are found to be more effective towards ULK copper decontaminantion and PER removal than other chelating agents, including other classes of diketones. These classes of diketones are particularly effective in decontaminating dielectric materials with a significant porosity. The presence of particular organic acids with such diketones in SC CO₂ can bring about highly effective PER removal. Accordingly, the diketone compounds of the present invention have the formula R₁—CO—(Y)ₙ—CO—R₃, wherein Y═C(R₂)(R₂′), n=1-3, and R₁, R₂, R₂′, and R₃ are each independently selected from the group consisting of: hydrogen, alkyl, aryl, fluorine-substituted alkyl, alkoxy, furyl, substituted furyl, thienyl, and substituted thienyl. It is preferable that such ketones are in the liquid phase under the conditions of use with the present invention.

β-diketones, i.e., diketones of formula R₁-CO—C(R₂)(R₂′)—CO—R₃, are particularly effective decontaminating and cleaning species and are further preferred because such diketones are easy to dissolve in SC CO₂ because their respective enolate forms are more stable than their keto forms. Furthermore, it has been shown that fluorination, including perfluorination, of groups R₁ and R₃ accentuates the stability of the enolate forms and hence their solubility in SC CO₂ (see, e.g., S. L. Wallen, C. R. Yonker, C. L. Phelps, and C. M. Wai, “Effect of fluorine substitution, pressure and temperature on the tautomeric equilibria of acetylaceotonate β-diketones”, J. Chem. Soc. Faraday Trans., 93(14), 2391-2394, (1997)). Accordingly, groups R₁ and R₃ are preferably independently selected from the group consisting of: fluoromethyl, difluoromethyl, trifluoromethyl, perfluoroethyl, and perfluoropropyl.

According to the present invention, the diketone compound is preferably selected from the group consisting of: acetonylacetone (CH₃COCH₂CH₂COCH₃), acetylacetone (CH₃COCH₂COCH₃), trifluoroacetylacetone (CF₃COCH₂COCH₃), hexafluoroacetylacetone (CF₃COCH₂COCF₃, “hfac”), thienyltrifluoroacetylacetone (CF₃COCH(C₄H₃S)COCH₃), 2,2-dimethyl-6,6,7,7,8,8,8-heptafluoro-3,5-octanedione (CH(Me)₂COCH₂COCF₂CF₂CF₃), and 2,2,6,6-tetramethylheptane-3,5-dione (C(Me)₃COCH₂COC(Me)₃). It is particularly preferable that the diketone for use with the present invention is non-volatile, and thus is easy to mix with SC CO₂. It is especially preferred that the diketone employed is acetonylacetone. It is also preferred that only one of the groups R₁ and R₃ is fluorinated in the diketones of the present invention, as in, for example, trifluoroacetylacetone.

SC CO₂ by itself is not necessarily an effective solvent for all organic molecules, and particularly polar molecules. Accordingly, a co-solvent is preferably employed to improve solubility of the chelating agent in SC CO₂. Such a co-solvent is preferably polar enough to dissolve polar materials that may be liberated from the substrate, but not so non-polar that it won't dissolve the chelating agent. One indicium that may be used to select a suitable co-solvent is its permittivity. Preferably co-solvents for use with the present invention have a permittivity that is in the range about 3 to about 30. Even more preferably, such co-solvents have a permittivity in the range of about 10 to about 20.

Accordingly, the solvent may be a substituted aliphatic hydrocarbon, including an alcohol, amine, amide, alkyl halide, alcohol amine, halocarbon, ketone, and combinations thereof. In particular, the cleaning composition of the present invention preferably contains a co-solvent selected from the group consisting of: short chain (from 1 to 10 carbon, and even more preferably from 1 to 5 carbon) aliphatic alcohols, cyclic ethers with 3 to 8 carbon atoms, lactones with 4 to 8 carbon atoms, and monocyclic heterocycles. It is therefore to be understood that suitable co-solvents may be aprotic, and may be apolar. In preferred embodiments, the co-solvent is selected from the group consisting of: ethanol, isopropyl alcohol, decanol, butyne-2-one, dimethyl acetamide, monoethanolamine, diethanolamine, isopropanolamine, diglycolamine (2-amino-2-ethoxy ethanol), aniline, and γ-butyrolactone. Ethanol is especially preferably used because of its high solubility in SC CO₂ (see, e.g., J. Liu, W. Wang, G. Li, Talanta Oxford, 53, 1149-1154, (2001)). If the polar compound used in conjunction with super-critical CO₂ is an amine, it is preferably not a quaternary amine. It is additionally desired that the chosen solvent is in the liquid phase under the conditions of use with the present invention.

The cleaning composition of the present invention, when applied to post-etch residue removal and removal of low-k contaminants that have been exposed to plasma, preferably contains an organic acid. Preferred acids for use with the present invention preferably are able to solubilize material in the SC CO₂. It has been found that strong acids such as inorganic acids H₂SO₄, or HNO₃, are impractical because of their low solubility in SC CO₂, and that some organic acids—even a strong organic acid such as CF₃COOH—are not practical because they do not react with contaminants such as Cu₂O. In practice, the preferred acids for use with the present invention have a pKa in the range 3-6, preferably around 4-5, and comprise an alkyl ester of an inorganic acid. Thus, preferred acids for use with the present invention include alkyl and alkyl-substituted aryl esters of phosphonic acid, sulfuric acid, and nitric acid. In particular, an especially preferred acid for use with the present invention is C₁₂H₂₅C₆H₄SO₄H (dodecyl benzene sulfonic acid, “DDBSA”). Another preferred acid is methanesulfonic acid (“MSA”).

In general, the desired properties of the acids for use with the present invention are that they should be strong enough to attack formations on the substrate—such as CuO or PER—but also be soluble in SC CO₂. It has been observed that long alkyl chains on the acid compounds are effective at promoting micelle formation.

Accordingly, acids for use with the methods and compositions of the present invention have a formula: R—Ar—XOₘHₚ, wherein R is an hydrocarbon chain—straight or branched—with from 1 to 20 carbon atoms, preferably from 5 to 15 carbon atoms, and even more preferably 12 carbon atoms, and wherein a number of hydrogens on R may be substituted with an equivalent number of fluorine atoms, and wherein Ar is optionally present and represents an arylene group such as phenylene, naphthylene, anthracenyl, in which any two of its substitutable positions is occupied, and wherein XOₘ represents an inorganic acid group wherein X is S, N, P, Se, or As, and wherein m is a number between 1 and 4 and p is a number between 1 and 3 such that the normal valences of the atom X are satisfied. In preferred embodiments, XOₘHₚ is selected from the group consisting of: NO₂H, NO₃H, SO₃H, SO₄H, PO₃H, and PO₄H₂. It is preferable that R is a saturated aliphatic chain.

Supercritical CO₂ is also known to have trace water—typically at levels of around 0.5% by weight—which creates corresponding trace quantities of carbonic acid.

It is consistent with the methods and compositions of the present invention that additional components may be added to the super-critical CO₂ formulation. Examples of such additional components include one or more corrosion inhibitors, and one or more surfactants.

The compositions of the present invention preferably comprise: about 4% by volume of co-solvent, about 4% by volume of acid, and about 4% by volume of chelating agent. The balance of such compositions is made up with SC CO₂. In one embodiment of the present invention, SC CO₂ is introduced into the reaction chamber in which the substrate is situated at a rate of about 6 liters per hour, and each of the other components is introduced into the chamber at a rate of from about 3-25 ml per minute. In such an embodiment, such other components are introduced at a rate of about 12 ml per minute.

Preferred reaction conditions for removal of copper containing contamination and PER using the methods and compositions of the present invention include: a temperature range of 40-90° C., and preferably around 50° C.; a pressure of 300 bar or less, preferably less than 200 bar, and preferably in the range 90-190 bars, and even more preferably at around 150 bars; and reaction times, for contact of chelating agent, acid and co-solvent with the substrate, of between 20 seconds and 5 minutes, and preferably about 3 minutes.

The methods and compositions of the present invention may be deployed with any equipment for delivering a super-critical CO₂ composition to a substrate. Such equipment includes, but is not limited to, apparatus that employs total flow or pressure pulsing ways of applying the SC CO₂, as well as apparatus that uses plug flow to change solvents and conditions.

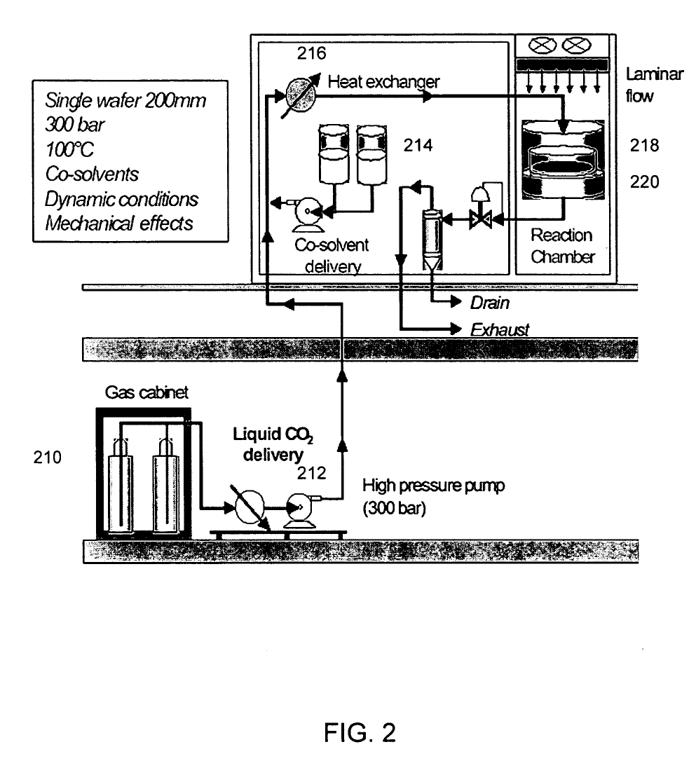

FIG. 2 shows a preferred apparatus for performing the methods of the present invention. In FIG. 2, liquid CO₂ is delivered from a gas cabinet 210, and compressed with a high pressure pump 212 to a pressure of around 300 bar. Other reagents 214, such as co-solvent, chelating agent, and acid, are mingled with the pressurized liquid CO₂ for a certain time, proportional to their respective concentrations in the mixture. Such times are preferably between 20 seconds and 5 minutes, and are preferably around 3 minutes. The mixture then passes through a heat exchanger 216 where it is heated to a temperature of around 100° C. The mixture then passes into the reaction chamber 218 which contains a silicon wafer 220 for a time sufficient for reacting with copper containing contaminants or PER. This time is preferably the same as the time for which the various reagents 214 are injected into the pressurized CO₂. Preferably, after reaction has taken place, a rinsing step occurs. Rinsing is preferably carried out with a solvent such as ethanol or DMAc. Such a solvent must dissolve the active ingredients in the reaction mixture and may include the co-solvent used therein. Subsequently, the chamber is depressurized and unused CO₂, co-solvent, chelating agent, or acid and any gaseous exhausts are drained off, or vented. The overall time taken for the entire process, from pressurizing the CO₂ to cleaning the wafer, rinsing the wafer, and to depressurizing the chamber, may take for example, around 10 minutes, but may take greater or lesser time, as required for the particular application. A certain portion of the liquid component after depressurizing the chamber may be recycled for improved environmental and economic considerations.

It is further envisaged that the methods of the present invention can be employed using an alternative supercritical fluid to CO₂; such fluids include supercritical NH₃ and SO₃.

### EXAMPLE 1

### Experimental Conditions

After dielectric etching it was demonstrated that for the 0.25 μm technologies, Cu contamination on backend dielectrics can be very high (1^{E}14 to 1^{E}16 at/cm²). It has been suggested that a residual Cu level under 1^{E}13 at/cm² at the insulator's surface and sidewall interfaces and lower than 1^{E}11 at/cm² range on the backside are necessary (see, e.g., F. Tardif, A. Beverina, H. Bernard, I. Constant, F. Robin, J. Torres, Proceedings of the 1999 Electrochemical Society Conference, (1999)).

With the aim of studying Cu residue cleaning in similar conditions, different copper species including Cu(0), Cu(I) and Cu(II) bulk and surface types were investigated at an equivalent Cu level range for two purposes.

First, in order to study post etch residues (PER) removal, SC CO₂ cleaning processes were tested on damascene structures (cf. FIG. 1). In this case, the cleaning efficiencies were evaluated by SEM observations.

Second, to analyze accurately Cu decontamination on and within the ULK matrix, a similar cleaning study was carried out on blanket wafers. The samples were covered with a 3,000 Å thick ULK and intentionally contaminated with metallic copper at a level of a few ^{E}15 at/cm² using CVD. Some of the contaminated wafers were then exposed to ozone in order to oxidize part of Cu⁽⁰⁾ into CuO and Cu₂O. The quantitative determination of copper contamination in the material before and after SC CO₂ cleaning was performed by Vapor Phase Decomposition-Atomic Absorption Spectroscopy (VPD-AAS): AAS analysis of the total Cu contamination was performed after the complete decomposition of the native SiO₂ and ULK film by VPD.

All extraction mixtures tested in this study were balanced against a CO₂/hfac/ethanol cleaning mixture. In addition, fluid pressure and temperature are important parameters which compete with each other since the fluid density and extraction kinetic are directly related to them (see, e.g., J. Liu, W. Wang, G. Li, Talanta Oxford, 53, 1149-1154, (2001)). In the present study, the cleaning procedures were performed in a SC CO₂/solvent/chelating agent mixture at 50° C. and 180 bar under static conditions except for the charging and purging of pure CO₂.

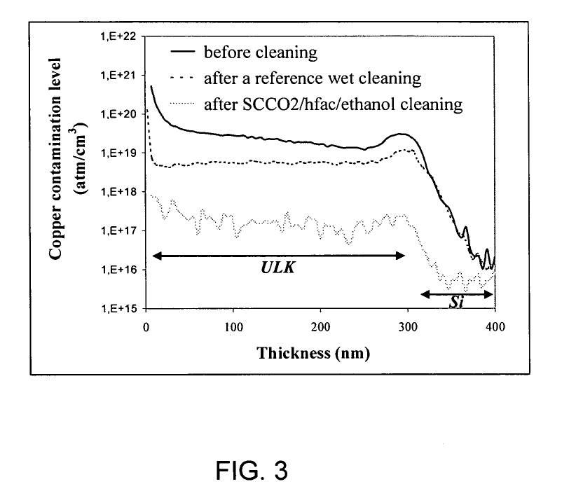

FIG. 3 shows SIMS analyses of SC CO₂ cleaning on copper contaminated ULK film compared to a reference wet clean. This result emphasizes the limitation of wet technologies to remove copper residues trapped within the porous low-k material. By contrast, SC CO₂-based treatment was efficient to decontaminate the ULK.

### EXAMPLE 2

### Copper Decontamination

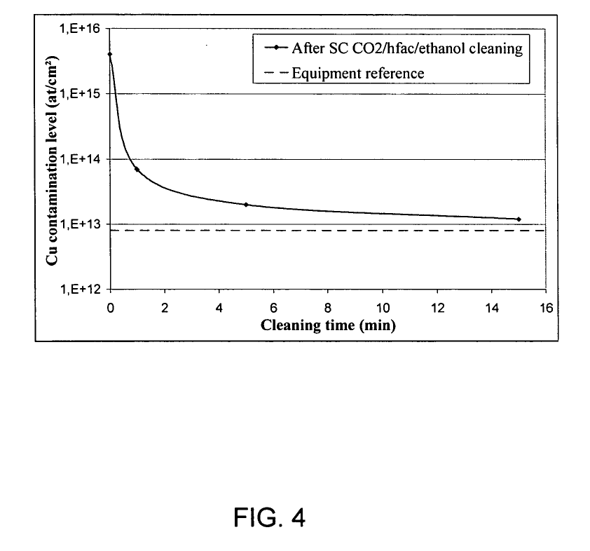

It was found that the efficiency of the cleaning process using SC CO₂ with additives depended on several parameters. On the one hand, the chemical reaction kinetic between copper residues and SC CO₂/additives would influence the extraction time and the choice between dynamic or static conditions. Different process times were tested, and the results demonstrate that a 5 min. static treatment can reach a cleaning efficiency greater than 99% (cf. FIG. 4). On the other hand, efficiency of SC CO₂ with additive mixtures would be influenced by the individual concentration ratios of additives on the quantity of copper residue removed. It was ascertained that the amount of chelating agent is several hundred times higher than the amount of Cu atoms present on the samples. Thus, given the high diffusivity of supercritical fluids, this concentration is not a limiting parameter. Furthermore, the molecular structure of the chelating agent can have an effect on the chelation mechanism and thus on the cleaning efficiency. Finally, the chelation performance in SC CO₂ can be altered by the poor dissociation effect of CO₂, and a lack of solubility of the additive within the solvent and/or CO₂.

### EXAMPLE 3

### Influence of the Chelating Agent Structure

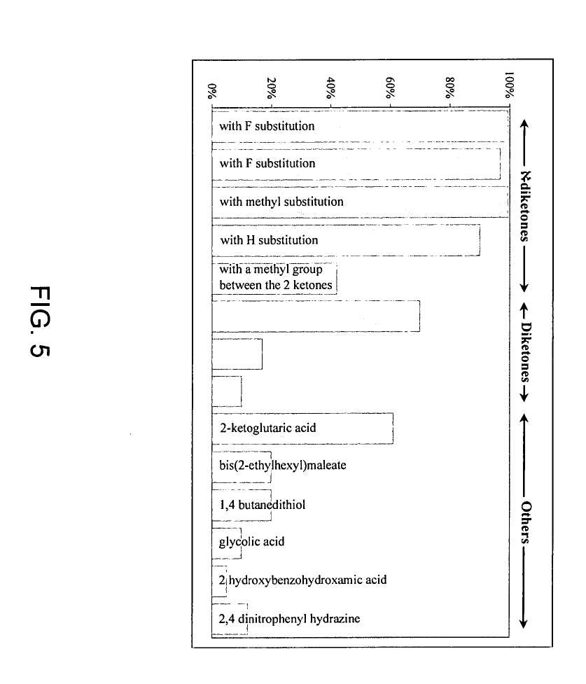

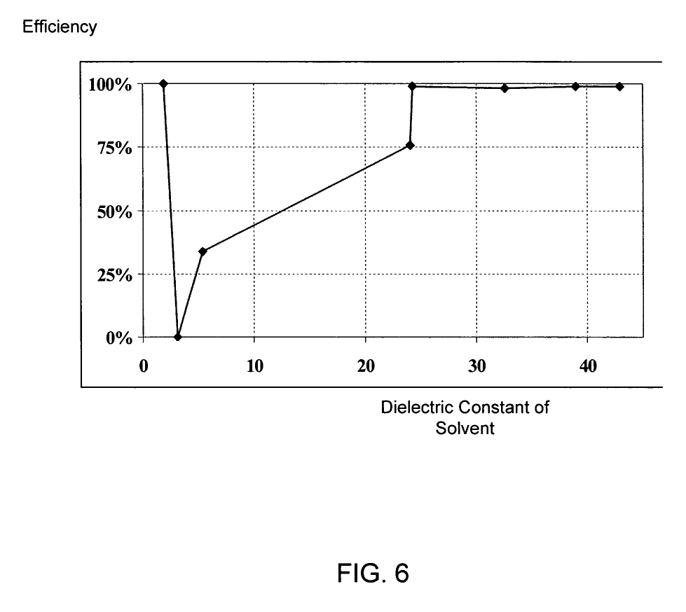

In order to understand chemical mechanisms taking place between the CO₂, co-solvent, additives and copper/copper residues at high pressure, and to choose an efficient extraction mixture, copper decontamination measurements of a wide range of organic chelating agents in SC CO₂ were carried out on copper contaminated ULK films. Also, the two first parameters previously proposed were chosen for not being limiting factors of the cleaning: 5 min. static process at a chelating agent concentration of about 1,000 ppm in CO₂. From literature results, this investigation was undertaken on diketone additives (see, e.g., J. Liu, W. Wang, G. Li, Talanta Oxford, 53, 1149-1154, (2001)). The two ketone groups were placed at different positions from one another on the hydrocarbon backbone in order to identify the optimal molecular structure(s). The analysis demonstrated that two classes of diketone chelating agents (including hfac) can more efficiently remove copper contamination from ULK matrix under supercritical conditions (cf. FIG. 5) than other chelating agents, including other classes of ketones.

Moreover, it was found that substitution can modify slightly the electron charge density within the carbon between the two ketone groups. Thus, it can alter the equilibrium between the enol and keto forms of the β-diketones which appeared to have an important role in metal complexation and on the chelation selectivity between copper and copper oxide species (see, e.g., J. Emsley and N. J. Freeman, Journal of Molecular Structure, 161, 193-204 (1987)).

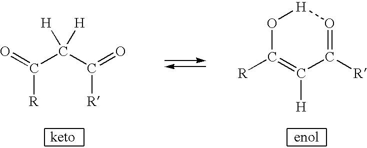

Also, the enol/keto ratio can be tuned by the co-solvent properties (in particular its dielectric constant) and the process conditions (pressure and temperature), in order to promote the enol form which accelerates formation of the metal chelate (see, e.g., S. L. Wallen, et al., J. Chem. Soc. Faraday Trans., 93(14), 2391-2394, (1997)).

Results on copper decontamination with hfac as a chelating agent and different solvents suggested that ethanol (k-value: 24.3) is polar enough to shift the equilibrium toward the enol form. However, keto/enol equilibrium alone could not explain all these results: another parameter that seems to influence chelation mechanisms is the available water quantity in the mixture.

### EXAMPLE 4

### Influence of Solubility of the Additive within the Solvent and/or CO₂

In addition, SC CO₂ cleaning ability of a chelating agent is almost certainly controlled by the solubility of the metal chelate within CO₂ (see, e.g., J. Liu, W. Wang, G. Li, Talanta Oxford, 53, 1149-1154, (2001)). Also, it is commonly understood that the solubility of a chemical in SC CO₂ depends on the permittivity, polarizability, and volatility of the species. In addition, Lagalante et al. (see, A. F. Lagalante, B. N. Hansen, T. J. Bruno, Inorganic Chemistry, 34, 5781, (1995)) demonstrated a good correlation between the solubility parameter (so substitution about the periphery of the complex) and the mole fraction solubility of copper(II)/1-diketonates in supercritical CO₂.

Therefore, the better cleaning ability of the β-diketones with methyl substitution or fluorine substitution (hfac) compared to non-substituted ones (cf. FIG. 5) can be explained by their better solubility in SC CO₂, as a result of the lower permittivity (methyl substitution) and lower polarizability (fluorine substitution) of the two respectively.

### EXAMPLE 5

### Metal and Oxidized Copper Selectivity

According to Sievers et al., during copper metal attack by hfac, copper is firstly oxidized before being chelated, see reaction (a).
2 C₅O₂H₂F₆(H₂O)₂+Cu⁽⁰⁾→CU(C₅O₂HF₆)₂+2H₂O+H₂ (a)

This oxidation can be performed by water molecules which are already in the cleaning blend or produced by the reaction between hfac and Cu^{(II)}O, as in reaction (b).
2 C₅O₂H₂F₆+CuO→CU(C₅O₂HF₆)₂+H₂O (b)

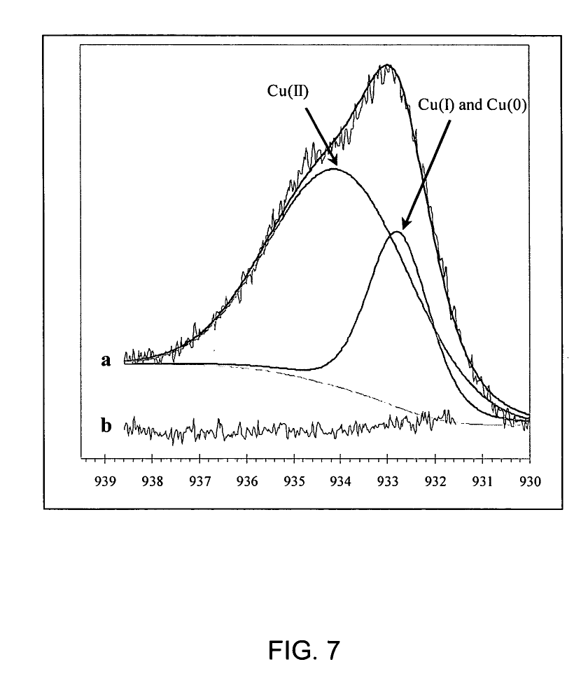

If this conclusion is generalized to other β-diketones, it is possible that a small water quantity present in SC CO₂ and/or in additives is able to hydrate a part of the chelating agent molecules. Thus, during the cleaning there is a sufficient amount of each ratio of chelating agent “states” (hydrated and not hydrated) to attack Cu(0), Cu(I) and Cu(II). Indeed, XPS analyses (cf. FIG. 7) highlighted that a CO₂/hfac/ethanol mixture was not selective between copper metal and oxidized copper, as a result the process conditions must be fully optimized so as to avoid attack of the copper lines. Some optimized compositions may completely exclude water, however.

### EXAMPLE 6

### Experimental Comparison of Various Diketones

Several diketones were used in supercritical carbon dioxide to determine the removal rate of atomic copper from the surface of ultra low-k dielectric surfaces. Conditions employed were a pressure of 170 bars, a temperature of 70° C., and a reaction time of 3 minutes. Results are presented in Table 1.

TABLE 1

| % Removal | Diketone |
|---|---|
| 99 | Hexafluoroacetylacetone |
| 94 | 2,2-dimethyl-6,6,7,7,8,8,8-heptafluor-3,5-octanedione |
| 100 | 2,2,6,6-tetramethylheptane-3,5-dione |
| 92 | 3,5-heptanedione, 1% |
| 77 | Acetonylacetone |

### EXAMPLE 7

### Experimental Investigation of Cross-Contamination

To investigate the potential for cross-contamination during a cleaning process, a non-contaminated porous ultra low-k fragment was exposed while cleaning a copper contaminated wafer piece using supercritical carbon dioxide plus diketone. The results showed that no additional amount of copper could be detected on the non-contaminated fragment compared to the reference value, while the copper contaminated fragment was cleaned of its copper impurities, demonstrating that no cross-contamination occurs.

### EXAMPLE 8

### Post Etch Residue Removal

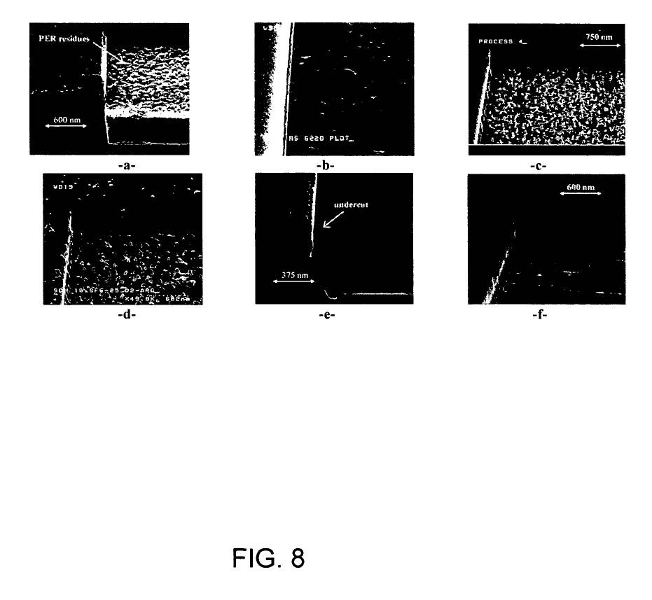

The cleaning performance of SC CO₂/additives was also studied for removing copper PER formed during the etching of the stop layer. The objective of this study was to achieve the complete removal of copper post-etch residue (“PER”) without extensive attack of the metal features and damage of the material stack. Indeed, an undercut can be observed at the metal/low-k interface (cf. FIG. 8 -e-) confirming the high diffusivity of the SC CO₂/additives throughout the porous material and the differences in properties between the copper/low-k interface and the rest of the copper bulk device. So, an important challenge of this new cleaning is the selectivity of the process between metallic copper of lines and oxidized copper in both polymer residues and copper line surfaces.

The cleaning ability and chemical compatibility of the cleaning process blend was assessed through SEM observations. From the many investigations performed, it was noticed that blends such as hfac/ethanol and in general chelating agent/co-solvent mixtures were ineffective in removing the copper PER (cf. FIG. 8 -c-). However, it was found that the joint effect of the chelating agent with a strong acid in the cleaning mixture was beneficial for PER removal (cf. FIG. 8 -d- compared to -f-). Indeed, results obtained with acid/chelating agent/solvent/CO₂ blends illustrated that it was possible to remove completely the copper PER without attacking the copper and ULK feature (cf. FIG. 8 -f-). Suitable acids include both organic and inorganic acids.

### EXAMPLE 9

### Optimization of Copper PER Cleaning using SC—CO₂ with Acetonyl Acetone

The purpose of this study was to optimize a formulation comprised of acetonyl acetone (AA), dodecyl benzene sulfonic acid (DDBSA) and ethanol for cleaning copper-containing PER. Initial work showed that a mixture of methyl sulfonic acid (MSA), AA and ethanol were also capable of removing copper PER for process parameters of 140 bars pressure, a temperature of 44° C., flow additives at 12.5 ml/min and a process time of 260 s. The main motivation behind the replacement of MSA by DDBSA within the blends is the poor stability of the mixture AA/MSA over time because of the hydrolysis of the AA by the very strong acid, MSA. DDBSA being a weaker acid improved the lifetime of the solution without a dramatic alteration of metal compatibility—i.e., corrosion of the metal—and cleaning performance. Clearly the most desirable composition is one that cleans effectively with minimal corrosion. The optimization process was supported by a design of experiment (DOE) and analyzed using the minitab statistical software. The blend compositions were calculated based on the amount of additives within the chamber. Therefore, to ensure a known amount of additives within the pressurized chamber, some slight adjustment of the flow rate of the additives was necessary for every solution.

The composition range was defined as: AA: 0.1 to 0.4%; DDBSA: 0.1 to 0.4%; EtOH: 2 to 10%; CO₂: balance, wherein fractions are by volume.

For technical reasons the CO₂ flow rate was not adjusted. Consequently the mixture flow rates were calculated for each blend by considering that the CO₂ flow was constant over time, at 110 ml/min so that the composition of each ingredient within the SC CO₂ chamber were close to the values defined within the DOE as shown in table 2. Mixture Flow rate is calculated according to the following formula:

$$\frac{{( AA \% + DDBSA \% + EtOH \% )}_{DOE}}{{( {CO}_{2} )}_{DOE}} \times \frac{100}{110} .$$

Eight solutions were made up for the DOE and the blends were processed at 140 bar, 50° C., for 3 minutes. The cleaning and metal compatibility of the blends was evaluated by SEM micrographs of patterned copper/JSR features. Also the copper decontamination ability of the blends was monitored on contaminated porous JSR fragments.

The cleaning processes investigated had the following compositions, labeled A-H:

TABLE 2

| | | | | | Injection rate |
|---|---|---|---|---|---|
| | AA | DDBSA | EtOH | CO₂ | ml/min |
| A | 0.4 | 0.1 | 10 | 89.5 | 10.7 |
| B | 0.1 | 0.4 | 2 | 97.5 | 2.3 |
| C | 0.1 | 0.4 | 10 | 89.5 | 10.7 |
| D | 0.4 | 0.4 | 2 | 97.2 | 2.6 |
| E | 0.4 | 0.4 | 10 | 89.2 | 11.0 |
| F | 0.1 | 0.1 | 10 | 89.8 | 10.3 |
| G | 0.1 | 0.1 | 2 | 97.8 | 2.0 |
| H | 0.4 | 0.1 | 2 | 97.5 | 2.3 |

From Table 2, the composition of the blends in AA, DDBSA and ethanol were calculated and formulated, and are shown in Table 3.

TABLE 3

| | name | AA | DDBSA | EtOH |
|---|---|---|---|---|
| A | CO2X-04-63 | 3.8095 | 0.9524 | 95.2381 |
| B | 64 | 4.0000 | 16.0000 | 80.0000 |
| C | 65 | 0.9524 | 3.8095 | 95.2381 |
| D | 66 | 14.2857 | 14.2857 | 71.4286 |
| E | 67 | 3.7037 | 3.7037 | 92.5926 |
| F | 68 | 0.9804 | 0.9804 | 98.0392 |
| G | 70 | 4.5455 | 4.5455 | 90.9091 |
| H | 71 | 16.0000 | 4.0000 | 80.0000 |

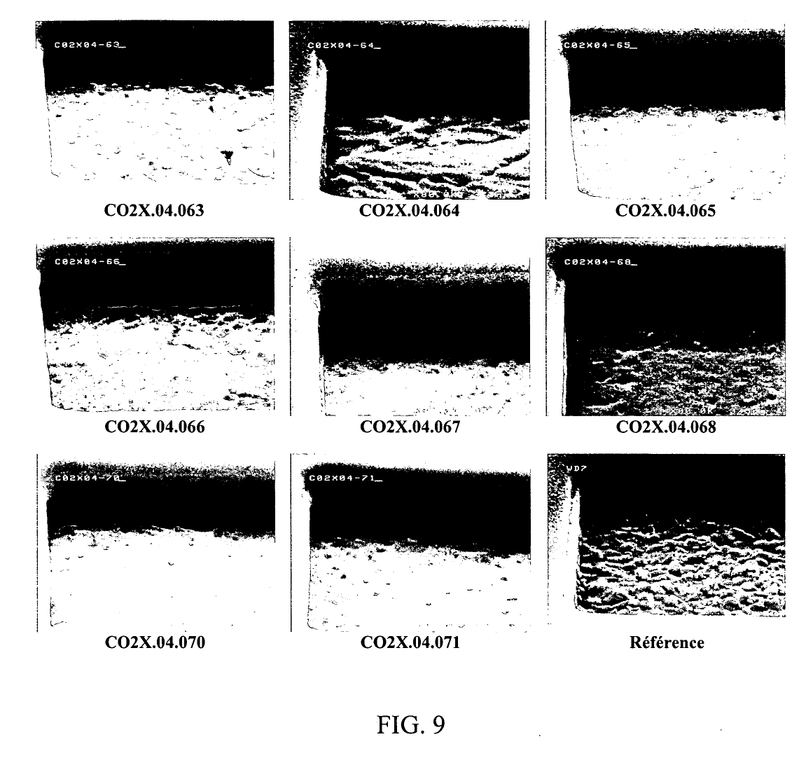

FIG. 9 presents tilted SEM micrographs of copper/JSR features after SC CO₂ treatment with the compositions from Tables 2 and 3.

The results indicated that within the composition range defined for the DOE, a wide range of cleaning and compatibility performances was observed for the 8 blends, A-H. From the SEM, the cleaning and compatibility performances were evaluated using a straightforward classification where results were marked on a scale of 0 to 10, with 10 representing the best results. Several persons performed the visual evaluation processes and the marks were averaged (Table 4) and used for the DOE computation.

TABLE 4

| Name | cleaning | corrosion |
|---|---|---|
| CO2X-04-63 | 6 | 7.5 |
| 64 | 9.75 | 6 |
| 65 | 7.25 | 7.5 |
| 66 | 9.75 | 6 |
| 67 | 8.5 | 8.5 |
| 68 | 6.5 | 9 |
| 70 | 8.5 | 6.75 |
| 71 | 6.5 | 9.75 |

In order to identify the main factors that control the cleaning and metal compatibility under SC CO₂ process, several statistical models were investigated with the following results. For the purpose of the mathematical model and optimization within the preferred component ranges, the best results were re-marked “1” and the worst were re-marked “8”, extrapolating between.

Linear Regression Analysis for Cleaning and Corrosion

Results are presented for DOE factorial-Flow rate. In respect of corrosion versus concentration of AA, DDBSA, EtOH, the regression equation is:
corrosion=5.76−4.58 AA+7.92 DDBSA−0.266 EtOH

with the following attributes: S=2.546; R-Sq=42.6%; and R-Sq(adj)=8.2%. Table 5 has further data in respect of this model.

TABLE 5

| Predictor | Coef | SE Coef | T | P |
|---|---|---|---|---|
| Constant | 5.760 | 2.654 | 2.17 | 0.082 |
| AA | −4.583 | 6.001 | −0.76 | 0.479 |
| DDBSA | 7.917 | 6.001 | 1.32 | 0.244 |
| EtOH | −0.2656 | 0.2250 | −1.18 | 0.291 |

In respect of cleaning versus concentration of AA, DDBSA, EtOH, the regression equation is:
cleaning=5.25+2.50 AA−12.5 DDBSA+0.375 EtOH

with the following data: S=1.500; R-Sq=80.8%; R-Sq(adj)=69.2%. Table 6 has further data in respect of this model.

TABLE 6

| Predictor | Coef | SE Coef | T | P |
|---|---|---|---|---|
| Constant | 5.250 | 1.564 | 3.36 | 0.020 |
| AA | 2.500 | 3.536 | 0.71 | 0.511 |
| DDBSA | −12.500 | 3.536 | −3.54 | 0.017 |
| EtOH | 0.3750 | 0.1326 | 2.83 | 0.037 |

The data clearly indicates that the acid, DDBSA, is driving the cleaning performance of the blends (coeff.=−12.5) but also provides the main mechanism of attack of the metal (coeff.=+7.92). On the other hand, AA seems to act as a classical inhibitor by decreasing the cleaning ability of the blends but improving the metal compatibility of those solutions (coeff.=−4.58). It should be noted that the regression coefficients are higher for the cleaning than for the corrosion.

The linear regression model is very useful but is a somewhat simplistic representation of the main factors because it does not take into account the potential interactions between the different ingredients. Therefore a 2 level factorial regression analysis has been carried out.

Two Level Factorial Regression Analysis

A fractional factorial fit was carried out to obtain a relationship between corrosion and concentrations of: AA, DDBSA, and EtOH. The model produced estimated coefficients for corrosion using data in uncoded units shown in Table 7.

TABLE 7

| Term | Coeff. |
|---|---|
| Constant | 6.07292 |
| AA | −13.9583 |
| DDBSA | 17.2917 |
| EtOH | −0.539396 |
| AA*EtOH | 2.65759 |
| DDBSA*EtOH | −0.467415 |
| AA*DDBSA*EtOH | −4.38034 |

A fractional factorial fit was carried out to obtain a relationship between cleaning and concentration of AA, DDBSA, and EtOH. The model produced estimated Coefficients for cleaning using data in uncoded units shown in Table 8.

TABLE 8

| Term | Coeff. |
|---|---|
| Constant | 0.909722 |
| AA | 19.8611 |
| DDBSA | −1.38889 |
| EtOH | 0.635417 |
| AA*DDBSA | −44.4444 |
| AA*EtOH | −1.04167 |

The two level factorial analysis confirmed the large effect of AA and DDBSA on the cleaning and compatibility performances of the blends as found with the linear regression models, but emphasized the important role played by the interactions of the ingredients, especially for AA-DDBSA in respect of cleaning, and the AA-DDBSA-EtOH interaction on compatibility.

The results reinforced the idea that a mixture of an acid and a chelating agent such as AA or HFAC are important to achieve selective cleaning and optimal metal compatibility.

Using the Minitab package and the factorial optimizer option, a statistical formulation was calculated, formulated and tested in the same conditions as the previous compositions.

A composition in the chamber of AA 0.25%, DDBSA 0.25%, EtOH 6%, and CO₂ 93.5 corresponds to the injection of a preferred blend, denoted CO2X04-69, that consists of AA 3.8%, DDBSA 3.8%, EtOH 92.4%, with a flow rate of 6.3 ml/min.

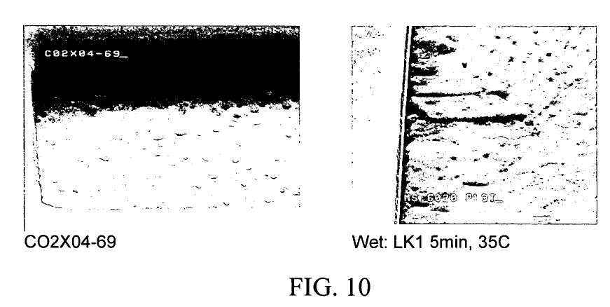

The results, see FIG. 10, confirmed that copper PER cleaning can be achieved under SC CO₂ without significant attack of the metal device and that SC CO₂ can compete with a traditional dilute organic PER cleaner such as LK1.

Copper Decontamination

The ability of the blends to decontaminate copper from low-K dielectrics was also measured by VPD-AAS. The results are shown in Table 9.

TABLE 9

| | Cu Contamination | % |
|---|---|---|
| Composition | (At./cm²) | decontamination |
| E780 P (reference) | 2.80E+15 | — |
| CO2X-04-063 | 1.10E+15 | 60.71 |
| CO2X-04-064 | 1.00E+15 | 64.29 |
| CO2X-04-065 | 9.80E+14 | 65.00 |
| CO2X-04-066 | 8.90E+14 | 68.21 |
| CO2X-04-067 | 1.00E+15 | 64.29 |
| CO2X-04-068 | 8.70E+14 | 68.93 |
| CO2X-04-069 | 9.40E+14 | 66.43 |
| CO2X-04-070 | 8.70E+14 | 68.93 |
| CO2X-04-071 | 1.10E+15 | 60.71 |

The results showed that under those process conditions and concentration ranges, the various compositions achieved significant decontamination of the contaminated porous low-k matrix.

Initial work showed that decontamination of JSR porous materials could be achieved in presence of a strong acid such as MSA or DDBSA at high concentration. However, these solutions are preferably avoided with Cu PER removal because of compatibility limitations with the metal interconnect features.

Influence of Water

The influence of water on the cleaning and compatibility performance of the blends was investigated because it has been important to identify the potential impact of water compared to anhydrous blends. The solution employed, CO2X.04-072, has composition: AA=3% DDBSA=3%, and Ethanol=94%.

An investigation was carried out on solutions containing different amounts of deionized water (DIW). The results showed that the presence of deionized water within the mixture did not significantly improve the decontamination ability, as shown in Table 10.

TABLE 10

| | | Cu | |
|---|---|---|---|
| | | Contamination | % |
| Composition | % DIW | (At./cm²) | decontamination |
| CO2X-04.072 | — | 1.10E+15 | 60.71 |
| CO2X-04.072a | 0.4% | 1.10E+15 | 60.71 |
| CO2X-04.072b | 1% | 1.10E+15 | 60.71 |
| CO2X-04.072c | 2% | 8.60E+14 | 69.29 |

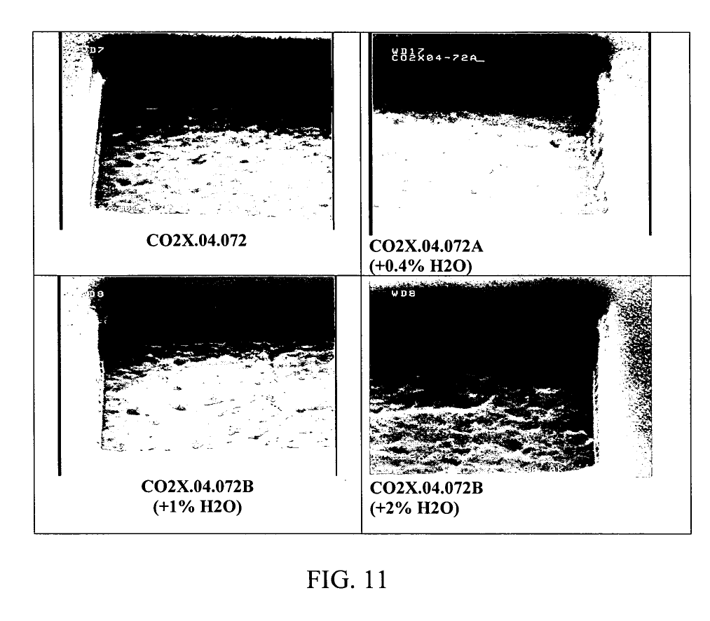

The SEM pictures (FIG. 11) showed that the presence of water does not significantly impact the cleaning and metal compatibility compared to the anhydrous blend as long as the water content still beneath 1-2% mark. Beyond this point, solubility limitation of water inside the pressurized chamber may occur and lead to stringent attack of the metal because of the very low pH of the mixture.

Influence of the Solvent

The solutions were based on the CO2X04-72a (3% AA+3% DDBSA+94% EtOH+0.4% H₂O) in which the EtOH content was replaced by γ-butyrolactone, butan 2-one, NMP, and IPA.

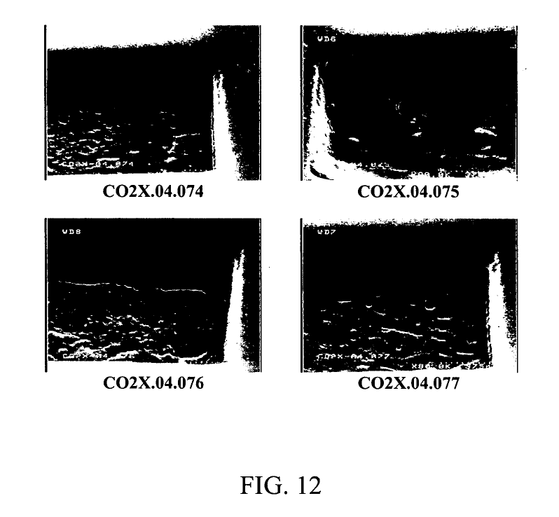

The property of the solvent can have a drastic impact on the overall cleaning and compatibility performance of the blends as shown by the SEM 75 (butan-2-one) and SEM 76 (NMP), see FIG. 12.

The deposit observed with the butan-2-one blend would tend to indicate that a strong interaction is taking place between the metal surface and the solution. The deposit could be either a butan-2-one-Cu complex or more likely an insoluble AA-Cu complex within the butan-2-one bulk. On another hand, the extensive attack of the copper surface in NMP could be explained by the poor solubility of the polar aprotic solvent and the condensation of an acidic solution onto the copper surface.

Finally, solvents such as IPA, EtOH and butyrolactone seem to foster the dissolution of the copper residues by the AA and DDBSA without altering the ingredient solubility within the blend and CO₂ bulk, therefore preventing deposition phenomena and extensive attack of the metal.

### EXAMPLE 10

### Copper Decontamination Ability of SC CO₂ with Additives on CVD and Spin-On Porous MSQ Materials

This example focused on the development of very dilute mixtures of chelating agents, acids and organic solvents for removal of post etch residue (PER), and copper (Cu) low-k decontamination under supercritical CO₂ for advanced nodes (<65 nm) BEOL integration. The Cu low-k decontamination ability of each mixture was carried out on Spin-On Dielectric (SOD) and Chemical Vapor Deposition (CVD) porous low-k. The copper decontamination ability of SC CO₂/additives systems were also studied on ashed and unashed low-k blanket wafers. Finally, this example compared the Cu decontamination performance and Cu PER removal ability of SC CO₂ systems that have additives compared to conventional wet chemistries.

The Cu decontamination study was carried out on two different commercial porous low-k dielectrics from JSR and Trikon. In order to mimic the nature of the low-k material surface and bulk during IC patterning, both materials were etched, ashed and contaminated using a CVD Cu procedure. The cleaning and decontamination ability of the SC CO₂/additive was bench-marked against wet PER solutions.

Experimental

The cleaning tests were performed within a 50 mm diameter pressurized chamber at 140 bar, 45 C, with a 2-10% additive mixture injected into the CO₂ flow for 3 minutes. These process conditions were determined previously by Design of Experiment (DOE) while optimizing the Cu PER cleaning and metal compatibility ability of the SC CO₂ with additives (see, e.g., C. Millet, J. Daviot, A. Danel, V. Perrut, F. Tardif, L. Broussous, O. Renault, Proceedings of the 2003 Electrochemical Society Conference, Orlando, (2003) and proceeding IITC 2004, 248).

A JSR spin-on material (JSR5109) and a Trikon CVD material (Orion® 2.4) were deposited on Si/SiO₂ substrates to a thickness of 300 nm. The JSR spin-on material was plasma etched in TEL unity and ashed with a CO/O₂ gas mixture in a Novellus Iridia tool. In another apparatus, Orion® CVD blankets were successively exposed to a plasma etch step and ashed with a H₂/He procedure. Both reference substrates and etched/ashed blanket wafers were intentionally contaminated with a 1 second CVD Cu deposition step leading to a Cu contamination of around 5E+15 atoms/cm². The copper contamination concentration and profile within the low-k stack was monitored by Vapor Phase Decomposition-Atomic Absorption Spectroscopy (VPD-AAS) and Secondary Ion Mass Spectroscopy (SIMS). The cleaning and metal stack compatibility of the SC CO₂ system with additives was assessed by SEM micrographs and compared to a commercial PER cleaner. A three factorial DOE was carried out with Minitab Version 14 using three concentrations as factors: acid, chelating agent, and solvent. The two responses, cleaning and decontamination ability of the 9 solutions were tested on both JSR and Cu-JSR patterned wafers and used to optimized the additive blend composition.

Results and Discussion

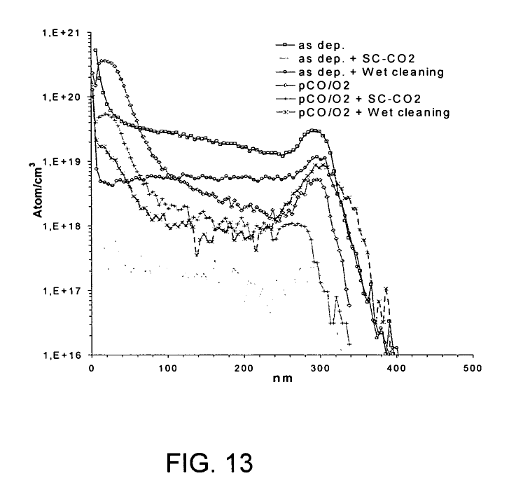

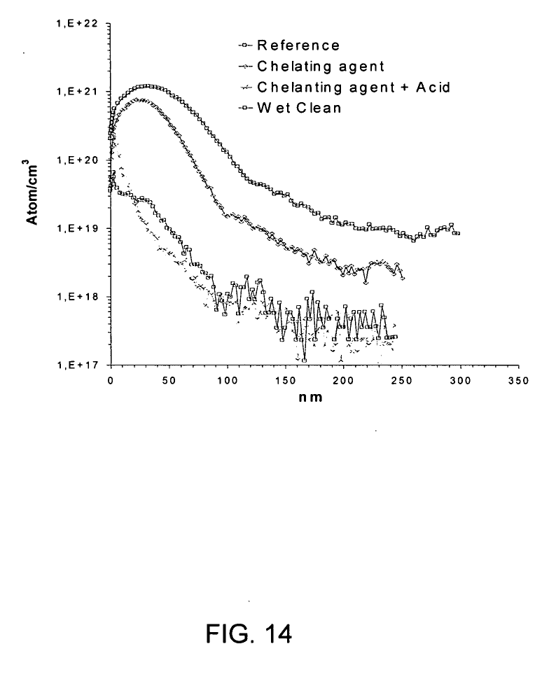

The distribution profiles and Cu contamination levels within the low-k matrices were determined by SIMS and VPD-AAS respectively. SIMS graphs (FIGS. 13, 14) emphasized the difference of Cu contamination profiles between the JSR ashed and unashed, and the impact of the plasma (reductive vs. oxidative). SIMS “reference as deposited” curves showed that the Cu contamination within the porous JSR material was spread throughout the 300 nm thick stack. A SC CO₂/additives system (Tables 11a and 11b) was capable of removing 99% of the contamination of the unashed JSR and Orion® materials due to the ability of SC CO₂ to diffuse freely through the film. However, the contamination of JSR after oxidative ash showed a concentration of the Cu level within the 100 nm on the surface (FIG. 13). It was suggested that the formation of hydrophilic functional species at the surface after oxidative plasma treatment hindered the diffusion of metal particles into the film. This effect can mainly be ascribed to the strong chemical interactions between the polar groups Si—OH, Si═O and SiOSi, formed during the ashing process, and the Cu species. In the case of Orion®, the high Cu surface concentration observed (FIG. 14) was explained by the densification of the material at the surface interface during the reductive plasma step. The 93% and 98% VPD-AAS removal results observed by wet cleaning on JSR and Orion® confirmed that most of the copper contamination was confined to the surface (Tables 11a and 11b).

TABLE 11a

| | VPD- | |
|---|---|---|
| JSR materials | AAS (atm/cm²) | % removed |
| As deposited + copper CVD deposition | | |
| Reference | 4.0E+15 | |
| After SCCO₂ | 2.0E+13 | 99.5 |
| After Wet Clean (LK1) | 2.4E+14 | 94 |
| Ash (p. CO/O₂) + Copper CVD deposition | | |
| Reference | 1.9E+15 | |
| After SCCO₂ | 1.7E+14 | 91 |
| After Wet Clean (LK1) | 1.3E+14 | 93 |
| DOE formulation results on E/A samples | | |
| Reference | 2.8E+15 | |
| Optimised SCCO₂ solution | 8.7E+14 | 69 |

TABLE 11b

| | VPD- | |
|---|---|---|
| Orion materials | AAS (atm/cm²) | % removed |
| As deposited + copper CVD deposition | | |
| Reference | 8.7E+14 | |
| After SCCO₂ | 1.2E+13 | 99 |
| Etch/Ash + copper CVD deposition | | |
| Reference | 7.80E+15 | |
| Chelating agent | 3.50E+15 | 55 |
| Chelating agent + Acid | 1.50E+14 | 98 |
| Wet Clean (LK1) | 1.50E+14 | 98 |
| DOE formulation results on E/A samples | | |
| Reference | 5.70E+15 | |
| Optimised SCCO₂ solution | 3.60E+14 | 94 |

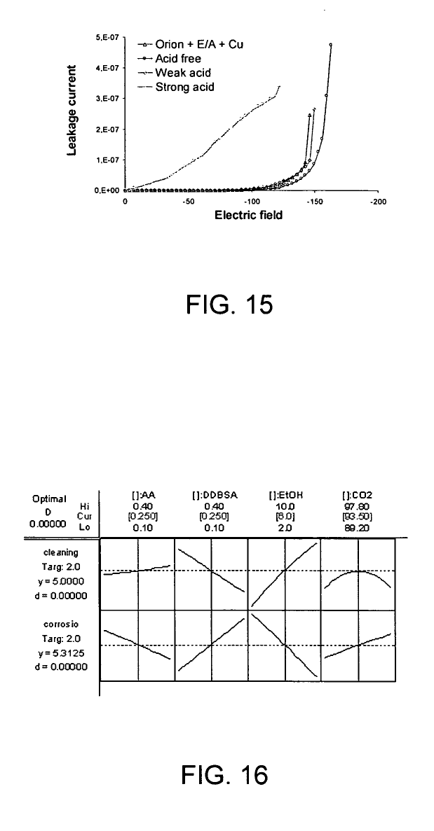

The addition of a polar species such as the acid DDBSA within the SC CO₂ flow significantly improved the decontamination of the Orion® sample from 55% to 98% (Tables 11a and 11b). It was proposed that the beneficial effect of the acid was twofold. The acid improved the dissolution of the copper oxide clusters trapped within the low-k matrix and also enhanced the removal ability of the chelating agent by lessening the polar interactions in the surface between SiOH and Cu. Leakage current studies showed that very strong acids had a detrimental effect on the electrical properties of the low-k dielectric materials compared to weaker acids (FIG. 15). The electrical results suggested that the strong acids may chemically modify low-k materials. However, it is also possible that the difference is due to the difficulty in rinsing highly polar species under SC CO₂. The poor solubility of most polar species within supercritical phases such as DMSO, NMP, water, amine, ammonium salts, and polyglycols is also a property of SC CO₂.

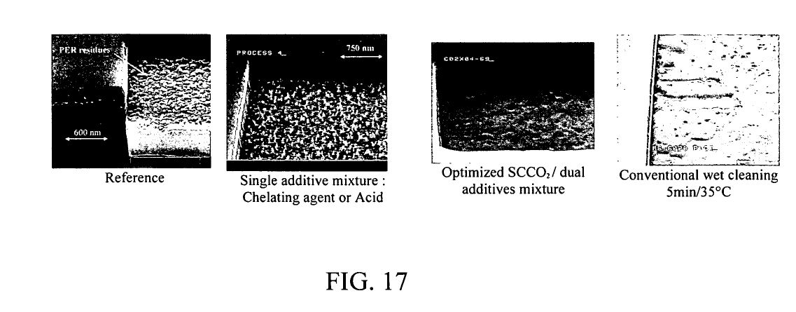

A three factorial DOE was established to investigate the PER cleaning and low-k decontamination efficiency using novel non-fluorinated reagents including the organic acid DDBSA, the chelating agent acetonyl acetone, and ethanol to enhance solubility. The results were used to run the mixture DOE optimizer response software package in order to assess statistically the main components and interaction effects. The mixture optimizer response graph (FIG. 16) showed clearly the main ingredients that affect Cu PER cleaning and metal corrosion. The optimizer plot clearly indicates that corrosion was mainly attributed to the acid content whereas cleaning is mainly governed by the chelating agent/ethanol content. From studying the interaction effects generated by the regression calculation, an interaction effect of the chelation agent and acid was identified as having a major impact on both cleaning efficiency and compatibility. SEM pictures (FIG. 17) confirmed that neither the solution of chelating agent or acid in ethanol alone were able to clean the PER residues. However by combining the acid and chelating agent, full cleaning was achieved without corrosion (FIG. 17).

The decontamination efficiency of the 9 experimental blends on the oxidative ashed JSR samples was around 70% compared to 91% seen previously. The lower decontamination efficiency of the blends was mainly due to a lower concentration of acid within the optimized PER cleaning solutions, previous studies have shown that more concentrated acidic solutions were able to reach 99% removal efficiency. The major drawback with the use of concentrated blends was that the mixtures were no longer Cu compatible and therefore unsuitable for Cu PER cleaning applications.

By contrast, the mixture with dual additives optimized by DOE and developed for SC CO₂ PER cleaning was capable of removing 94% of the Cu contamination entrapped within the reductive ashed Orion® material. The results clearly underlined the impact of the plasma gas mixture on the physico-chemical properties of the low-k material. The use of reductive gas mixtures for low-k ashing processes seemed more suitable than oxidizing alternatives because it reduces the formation of polar groups on surface. Therefore, the Cu decontamination ability of the dilute SC CO₂/additives can be significantly enhanced by using a plasma ash that reduces the formation of hydrophilic groups to which back sputtered Cu can bind.

The foregoing description is intended to illustrate various aspects of the present invention. It is not intended that the examples presented herein limit the scope of the present invention.

For example, one of ordinary skill in the art would understand that other additives may be used with the compositions herein, such as surfactants, chelating agents, and corrosion inhibitors, based on the preferences and requirements of the particular processes, contaminants and residues, provided that the additive is soluble in the supercritical composition to a not insubstantial extent and should not react detrimentally with the supercritical composition, for example to produce an insoluble product. These conditions generally apply to solvents that are used in the present invention. In addition, some combinations of more than one of the disclosed diketones and more than one of the disclosed solvents may be used in the compositions of the present invention.

The invention now being fully described, it will be apparent to one of ordinary skill in the art that many changes and modifications can be made thereto without departing from the spirit or scope of the appended claims.

All references cited herein are incorporated herein by reference in their entirety for all purposes.

1. A process for removing a copper-containing contaminant from a substrate comprising:
applying a cleaning composition that includes super-critical carbon dioxide; a diketone of formula: R₁—CO—(Y)ₙ—CO—R₃, wherein Y═C(R₂)(R₂′), n=1-3, and R₁, R₂, R₂′, and R₃ are each independently selected from hydrogen, alkyl, aryl, fluorine-substituted alkyl, alkoxy, furyl, substituted furyl, thienyl and substituted thienyl; and a co-solvent.

2. The process of claim 1 wherein the contaminant is copper.

3. The process of claim 2 wherein the substrate is porous.

4. The process of claim 1 wherein post etch residue is removed in addition to removing said copper-containing contaminant from said substrate, wherein the cleaning composition further comprises an acid having a formula: R—Ar—XOₘHₚ, wherein R is an aliphatic chain—straight or branched—with from 1 to 20 carbon atoms, preferably from 5 to 15 carbon atoms, and even more preferably 10 carbon atoms, and wherein a number of hydrogens on R may be substituted with an equivalent number of fluorine atoms, and wherein Ar is optionally present and represents an arylene group such as phenylene, naphthylene, anthracenyl, in which any two of its substitutable positions is occupied, and wherein XOₘ represents an inorganic acid group wherein X is S, N, P, Se, or As, and wherein m is a number between 1 and 4 and p is a number between 1 and 3 such that the normal valences of the atom X are satisfied.

5. The process of claim 4 wherein the acid is DDBSA.

6. The process of claim 1 wherein the diketone is acetonyl acetonate.

7. The process of claim 1 wherein the β-diketone is selected from the group consisting of: acetylacetone, trifluoroacetylacetone, hexafluoroacetylacetone, thienoyltrifluoroacetylacetone, and 2,2-dimethyl-6,6,7,7,8,8,8-heptafluor-3,5-octanedione and 2,2,6,6-tetramethylheptane-3,5-dione.

8. A cleaning composition consisting of:
super-critical carbon dioxide; a diketone of formula: R₁—CO—(Y)ₙ—CO—R₃, wherein Y═C(R₂)(R₂′), n=1-3, and R₁, R₂, R₂′, and R₃ are each independently selected from hydrogen, alkyl, aryl, fluorine-substituted alkyl, alkoxy, firyl, substituted furyl, thienyl and substituted thienyl; and a co-solvent.

9. The cleaning composition of claim 8, additionally comprising an acid having a formula: R—Ar—XOₘHₚ, wherein R is an aliphatic chain—straight or branched—with from 1 to 20 carbon atoms, preferably from 5 to 15 carbon atoms, and even more preferably 10 carbon atoms, and wherein a number of hydrogens on R may be substituted with an equivalent number of fluorine atoms, and wherein Ar is optionally present and represents an arylene group such as phenylene, naphthylene, anthracenyl, in which any two of its substitutable positions is occupied, and wherein XOₘ represents an inorganic acid group wherein X is S, N, P, Se, or As, and wherein m is a number between 1 and 4 and p is a number between 1 and 3 such that the normal valences of the atom X are satisfied.

10. The cleaning composition of claim 9, wherein the diketone is selected from the group consisting of: acetylacetone, trifluoroacetylacetone, hexafluoroacetylacetone, thienoyltrifluoroacetylacetone, and 2,2-dimethyl-6,6,7,7,8,8,8-heptafluor-3,5-octanedione and 2,2,6,6-tetramethylheptane-3,5-dione.

11. The cleaning composition of claim 8, wherein the diketone is acetonyl acetonate.

12. An apparatus for performing the method of claim 1.
